(19) United States
(12) Patent Application Publication
(10) Pub. No.: US 2021/0247766 A1
(43) Pub. Date: Aug. 12, 2021

(54) INFORMATION PROCESSING APPARATUS, INFORMATION PROCESSING METHOD, AND VEHICLE

(71) Applicant: TOYOTA JIDOSHA KABUSHIKI KAISHA, Toyota-shi (JP)

(72) Inventors: Katsuhisa YOSHIKAWA, Toyota-shi (JP); Yuji SUZUKI, Kariya-shi (JP); Keita YAMAZAKI, Nisshin-shi (JP); Kei MATSUMOTO, Toyota-shi (JP); Hiroyuki ITO, Nagoya-shi (JP); Takashi OGAWA, Toyota-shi (JP); Yukiya SUGIYAMA, Toyota-shi (JP); Masaru ANDO, Seto-shi (JP); Yasushi FUJIWARA, Toyota-shi (JP); Azusa NAKAGAME, Kariya-shi (JP); Erina TOYAMA, Toyota-shi (JP)

(73) Assignee: TOYOTA JIDOSHA KABUSHIKI KAISHA, Toyota-shi (JP)

(21) Appl. No.: 17/171,440

(22) Filed: Feb. 9, 2021

(30) Foreign Application Priority Data
Feb. 12, 2020 (JP) 2020-021701

(51) Int. Cl. G05D 1/00; G05D 1/02

(52) U.S. Cl. CPC G05D 1/0088; G05D 1/0016; G05D 1/0212

(57) ABSTRACT

There is provided a technology that can improve the convenience of users of vehicles. When receiving a vehicle dispatch request containing information designating kitchen equipment and food materials, an information processing apparatus disclosed determines a first unit provided with the kitchen equipment designated by the vehicle dispatch request and a second unit capable of storing the food materials designated by the vehicle dispatch request. The information processing apparatus sends a composition command to a specific composition site. The composition command is a command to compose a vehicle body unit including the first unit and the second unit. Moreover, the information processing apparatus sends an operation command to a chassis unit. The operation command is a command to cause the chassis unit to travel with the vehicle body unit composed at the specific composition site mounted thereon.

### CROSS REFERENCE TO RELATED APPLICATION

This application claims the benefit of Japanese Patent Application No. 2020-021701, filed on Feb. 12, 2020, which is hereby incorporated by reference herein in its entirety.

### BACKGROUND

### Technical Field

This disclosure relates to technologies pertaining to management of separable vehicles.

### Description of the Related Art

There are known separable vehicles constructed by combining a plurality of separable units (see, for example, Patent Document 1 in the citation list below).

### CITATION LIST

### Patent Literature

Patent Literature 1: DE 10 2009 057 693

### SUMMARY

An object of this disclosure is to provide a technology that can improve the convenience of users of vehicles.

Disclosed herein is an information processing apparatus. The information processing apparatus may comprise a controller equipped with at least one processor,

the controller configured to execute the processing of

receiving a vehicle dispatch request containing information designating kitchen equipment used to make a meal and information designating a food material used to make a meal;

determining a first unit provided with the kitchen equipment designated by the vehicle dispatch request and a second unit capable of storing the food material designated by the vehicle dispatch request;

sending a composition command to a specific composition site, the composition command being a command to compose a vehicle body unit including the first unit and the second unit; and

sending an operation command to a chassis unit capable of traveling autonomously on which a plurality of units can be mounted, the operation command being a command to cause the chassis unit to travel with the vehicle body unit composed at the specific composition site mounted thereon.

Also disclosed herein is an information processing method. The information processing method may comprise the following steps of processing executed by a computer:

receiving a vehicle dispatch request containing information designating kitchen equipment used to make a meal and information designating a food material used to make a meal;

determining a first unit provided with the kitchen equipment designated by the vehicle dispatch request and a second unit capable of storing the food material designated by the vehicle dispatch request;

sending a composition command to a specific composition site, the composition command being a command to compose a vehicle body unit including the first unit and the second unit; and

sending an operation command to a chassis unit capable of traveling autonomously on which a plurality of units can be mounted, the operation command being a command to cause the chassis unit to travel with the vehicle body unit composed at the specific composition site mounted thereon.

Also disclosed herein is a vehicle. The vehicle may comprise a controller equipped with at least one processor,

the controller configured to execute the processing of;

receiving a vehicle dispatch request containing information designating kitchen equipment used to make a meal and information designating a food material used to make a meal;

determining a first unit provided with the kitchen equipment designated by the vehicle dispatch request and a second unit capable of storing the food material designated by the vehicle dispatch request;

sending a composition command to a specific composition site, the composition command being a command to compose a vehicle body unit including the first unit and the second unit;

creating an operation plan for traveling with the vehicle body unit composed at the specific composition site mounted on the vehicle; and

operating pursuant to the operation plan.

Also disclosed herein is an information processing program configured to cause a computer to execute the above-described information processing method and a non-transitory storage medium that stores the information processing program in a computer-readable manner.

Also disclosed herein is a system that causes the chassis unit to operate with the vehicle body unit including the first unit and the second unit determined by the information processing apparatus mounted thereon.

This disclosure can provide a technology that can improve the convenience of users of vehicles.

### BRIEF DESCRIPTION OF THE DRAWINGS

FIG. 1 is a diagram illustrating the general configuration of a vehicle dispatch system.

FIG. 2 is a first diagram illustrating the general configuration of a separable vehicle.

FIG. 3 is a second diagram illustrating the general configuration of the separable vehicle.

FIG. 4 is a diagram illustrating the hardware configurations of a chassis unit and a server apparatus.

FIG. 5 is a block diagram illustrating an exemplary functional configuration of the chassis unit.

FIG. 6 is a block diagram illustrating an exemplary functional configuration of the server apparatus.

FIG. 7 illustrates an exemplary structure of a unit information table.

FIG. 8 illustrates an exemplary structure of a chassis information table.

FIG. 9 is a flow chart of a process executed by the server apparatus.

### DESCRIPTION OF THE EMBODIMENTS

The technology disclosed herein provides to a user who travels by a vehicle an environment in which he or she can make a meal while traveling, thereby improving the convenience of the user.

If the user (who may be e.g. a worker) prepares a meal after returning home, the task done after returning home can be burdensome, or the time to start eating the meal can get late. If the user prepares a lunch (boxed lunch) before going to work, the task done before going to work can be burdensome, or the user may have to get up early.

The technology according to the present disclosure employs a separable vehicle as a vehicle used for travel of a user. The separable vehicle includes a vehicle body unit and a chassis unit. The vehicle body unit is a unit including a plurality of units as its components. The vehicle body unit disclosed herein includes a first unit provided with kitchen equipment tailored to user preferences and a second unit that can store food materials tailored to user preferences. The units used as components of the vehicle body unit are not limited to the first and second units, but the vehicle body unit may further include additional units, such as a unit provided with a cabin for the user, a unit provided with water supply equipment, and a unit provided with wastewater-treatment equipment, when necessary. Alternatively, the first unit or the second unit may be provided with a cabin for the user, water supply equipment, or wastewater-treatment equipment. The chassis unit disclosed herein is a unit on which a plurality of units can be mounted. The chassis unit is a mobile unit capable of traveling autonomously on the road by autonomous driving. The essential function of the chassis unit is driving on the road, and it is not necessary for the chassis unit to have a space (like cabin) for occupants. The chassis unit may be a mobile unit that is driven manually by a human driver other than the user.

The composition of the vehicle body unit and the operation of the chassis unit are controlled by an information processing apparatus. For example, a controller of the information processing apparatus may receive a vehicle dispatch request. The vehicle dispatch request contains information specifying kitchen equipment to be used to make a meal and information specifying food materials used to make a meal. The vehicle dispatch request may be sent to the information processing apparatus from a terminal used by a user directly or via a vehicle dispatch center or the like.

After receiving the vehicle dispatch request, the controller determines a first unit provided with kitchen equipment specified by the vehicle dispatch request and a second unit that can store food materials specified by the vehicle dispatch request. Moreover, the controller sends a command for composing a vehicle body unit including the first unit and the second unit (which will be referred to as a “composition command”) to a specific composition site. The composition command also includes information about items of food materials to be stored in the second unit and the respective amounts thereof. The specific composition site to which the composition command is sent is a composition site where the first unit and the second unit are available, among the composition sites under the management of the information processing apparatus. To determine (or select) the specific composition site, the information processing apparatus may be provided with a first storage unit in which information about the types of units available at each composition site. The controller may determine the specific composition site on the basis of data stored in the first storage unit.

The controller sends a command to a chassis unit to cause it to travel with a vehicle body unit composed of a plurality of units including the first and second units mounted thereon. This command will be referred to as an “operation command”. To determine (or select) the chassis unit to which the operation command is to be sent, the information processing apparatus may be provided with a second storage unit in which information about the locations of the chassis units under the management of the information processing apparatus and information about the operation statuses thereof are stored in a linked manner. The controller may determine the chassis unit to which the operation command is to be sent (i.e. the chassis unit that is caused to travel with the vehicle body unit mounted thereon) on the basis of data stored in the second storage unit.

The vehicle body unit is composed by assembling a plurality of units including the first and second units at the specific composition site that has received the aforementioned composition command. The operation of storing the food materials specified by the composition command in the second unit is also performed at the composition site. Moreover, the vehicle body unit is mounted on the chassis unit that has received the operation command at the composition site. Thus, a separable vehicle having settings with which the user can make a meal is constructed. The user aboard this separable vehicle can make a meal using the kitchen equipment of the first unit and the food materials stored in the second unit while traveling by the separable vehicle. In other words, the user can make a meal during the time of travel by the separable vehicle. This can improve the convenience of the user.

The vehicle dispatch request according to this disclosure may further contain information about places at which the user wishes to get on and off the separable vehicle, which will also be referred to as “the place of (user's) getting-on/getting-off”. The controller may send to the chassis unit an operation command including a command to transport the user from the place of getting-on to the place of getting-off. In this case, the operation command may include the following first to fifth commands:
first command: a command to couple the chassis unit to the vehicle body unit at the specific composition site
second command: a command to cause the chassis unit to travel from the specific composition site to the place of getting-on
third command: a command to pick up the user at the place of getting-on
fourth command: a command to cause the chassis unit to travel from the place of getting-on to the place of getting-off
fifth command: a command to drop off the user at the place of getting-off.

The chassis unit that has received the operation command operates firstly pursuant to the first command to mount the vehicle body unit on the chassis unit at the specific composition site. The operation of mounting the vehicle body unit on the chassis unit may be carried out by an external apparatus provided with a heavy machine, such as a lift or a crane. Alternatively, the operation of mounting the vehicle body unit on the chassis unit may be carried out by an apparatus provided on the chassis unit. After the vehicle body unit is mounted on the chassis unit in this way, the chassis unit travels autonomously by autonomous driving pursuant to the second command. Thus, the chassis unit can travel from the specific composition site to the place of getting-on with the vehicle body unit mounted thereon. After arriving at the place of getting-on, the chassis unit operates pursuant to the third command. In other words, the chassis unit performs the operation of letting the user get on the vehicle body unit. For example, the chassis unit sends to the vehicle body unit a command to unlock the entrance door or a command to automatically open and close the entrance door. The operation of the vehicle body unit pursuant to this command allows the user to get on the vehicle body unit. After the user gets on the vehicle body unit at the place of getting-on, the chassis unit restarts to travel pursuant to the fourth command. The chassis unit travels autonomously from the place of getting-on to the place of getting-off by autonomous driving pursuant to the fourth command. After arriving at the place of getting-off, the chassis unit operates pursuant to the fifth command to let the user get off the vehicle body unit. For example, the chassis unit sends to the vehicle body unit a command to unlock the entrance door and/or a command to automatically open and close the entrance door. The operation of the vehicle body unit pursuant to this command allows the user to get off the vehicle body unit. By operating pursuant to the first to fifth command, the chassis unit can travel from the place of getting-on to the place of getting-off with the vehicle body unit including the first and second units and the user riding therein. This enables the user to make a meal using the kitchen equipment of the first unit and the food materials stored in the second unit while traveling from the place of getting-on to the place of getting-off.

The fare the user who uses the separable vehicle as above is charged may be determined as a fare including a fee for the use of the units of the vehicle body unit. For example, the controller may calculate the fare on the basis of a first fee for the use of the first unit, a second fee for the use of the second unit, and a third fee for the transportation from the place of getting-on to the place of getting-off. Thus, it is possible to charge the user a fare commensurate with the kitchen equipment and the food material used by the user.

The first fee may be calculated on the basis of the type of the kitchen equipment provided in the first unit. Thus, it is possible to charge the user a fee commensurate with the kitchen equipment used by the user. The second fee may be calculated on the basis of the items of the food materials stored in the second unit and the amounts thereof. Thus, it is possible to charge the user a fee commensurate with the items of food materials used by the user and the amounts thereof. The third fee may be calculated on the basis of at least one of the travel distance from the place of getting-on to the place of getting-off and the time of travel from the place of getting-on to the place of getting-off. Thus, it is possible to charge the user a fee commensurate with the distance and/or the time through which the user has traveled in the vehicle body unit.

In the following, a specific embodiment of the technology disclosed herein will be described with reference to the drawings. It should be understood that dimensions, materials, shapes, relative arrangements, and other features of the component that will be described in connection with the embodiment are not intended to limit the technical scope of the disclosure only to them, unless otherwise stated.

### Embodiment

What will be described in the following as an embodiment is a case where the information processing apparatus according to this disclosure is applied to a system that provides vehicle dispatch services in response to requests from users. This system will also be referred to as the “vehicle dispatch system” hereinafter.

### (General Configuration of Vehicle Dispatch System)

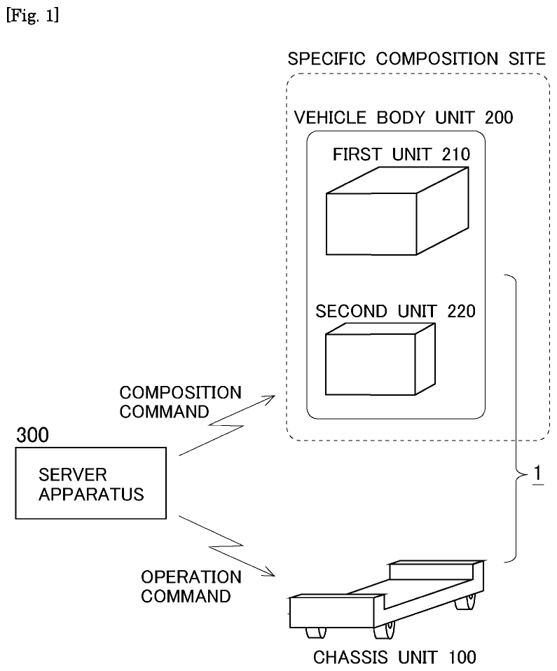

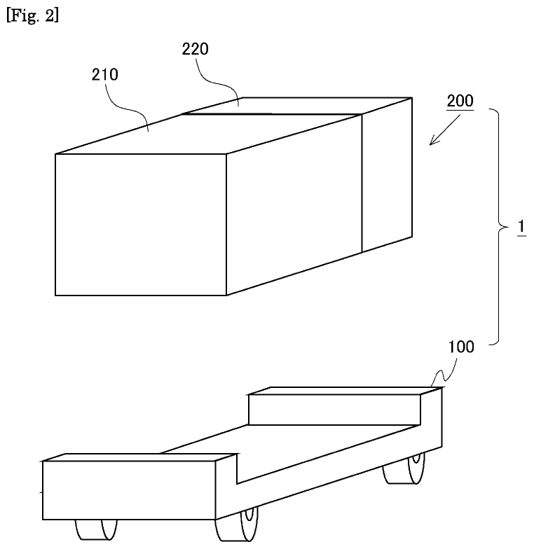

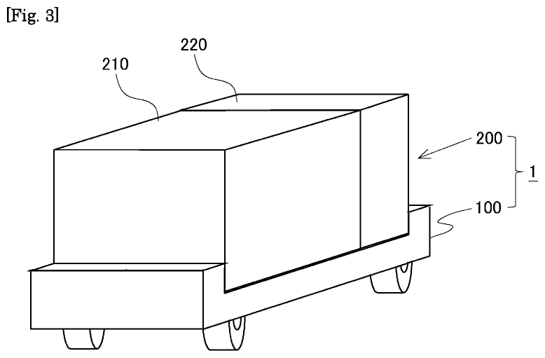

FIG. 1 is a diagram illustrating the general configuration of the vehicle dispatch system. The vehicle dispatch system according to this embodiment provide the service of dispatching a separable vehicle 1. As illustrated in FIG. 1, the vehicle dispatch system of this embodiment includes a separable vehicle 1 and a server apparatus 300. As illustrated in FIGS. 2 and 3, the separable vehicle 1 includes a chassis unit 100 and a vehicle body unit 200, which can be coupled to and separated from each other. FIG. 2 illustrates the chassis unit 100 and the vehicle body unit 200 in the decoupled (or separated) state. FIG. 3 illustrates the chassis unit 100 and the vehicle body unit 200 in the coupled state. The chassis unit 100 is a unit capable of traveling on the road autonomously by autonomous driving. The vehicle body unit 200 includes a first unit 210 provided with kitchen equipment and second unit 220 in which food materials can be stored. The kitchen equipment provided in the first unit 210 may include, for example, a cooking heater, a microwave oven, an oven, a sink, and other cookware. The second unit 220 may be a refrigerator, a freezer, or a room-temperature closet for storing foods. There are a plurality of first units 210 under the management of the server apparatus 300 in the system of this embodiment, which include units provided with different types of kitchen equipment. There are a plurality of second units 220 under the management of the server apparatus 300 in the system of this embodiment, which include units that can store items of food materials different from each other. The combination of the first unit 210 and the second unit 220 is varied according to the desired type of kitchen equipment and the desired items of food materials.

The combination of the first unit 210 and the second unit 220 is determined under the management of the server apparatus 300. Specifically, the server apparatus 300 determines a combination of a first unit 210 provided with kitchen equipment desired by the user and a second unit 220 that can store food materials desired by the user. Such a combination is determined based on a vehicle dispatch request made by a user. In the system according to this embodiment, the vehicle dispatch request contains information about kitchen equipment that the user wishes to use and information about food materials that the user wishes to use as well as information about the place of getting-on and the place of getting-off desired by the user. This enables the server apparatus 300 to select a first unit 210 provided with the kitchen equipment desired by the user and a second unit 220 that can store the food materials desired by the user. The server apparatus 300 sends a command to compose a vehicle body unit 200 including the first unit 210 and the second unit 220 thus selected to a specific composition site. The specific composition site is a composition site that can provide the combination of the first unit 210 and the second unit 220 determined as above among composition sites where vehicle body units 200 are composed by assembling a plurality of units. At the composition site to which the composition command has sent from the server apparatus 300, a vehicle body unit 200 is composed by assembling the first unit 210 and the second unit 220 determined by the server apparatus 300. The operation of composing the vehicle body unit 200 may be done either by automation or with human intervention. The operation of storing the food materials desired by the user into the second unit 220 is also performed at the specific composition site.

The server apparatus 300 determines also a chassis unit 100 on which the vehicle body unit 200 composed at the specific composition site is to be mounted. Then, the server apparatus 300 sends an operation command to the chassis unit 100 thus determined. The operation command is a command to cause the chassis unit 100 to transport the user from the place of getting-on to the place of getting-off with the vehicle body unit 200 composed at the specific composition site mounted thereon. When receiving the operation command, the chassis unit 100 firstly couples itself to the vehicle body unit 200 at the specific composition site. Thus, the vehicle body unit 200 is mounted on the chassis unit 100. Then, the chassis unit 100 travels autonomously from the specific composition site to the place of getting-on with the vehicle body unit 200 mounted thereon and picks up the user there. Then, the chassis unit 100 travels autonomously from the place of getting-on to the place of getting-off and drops off the user there. While traveling from the place of getting-on to the place of getting-off, the user can make a meal using the kitchen equipment of the first unit 210 and the food materials stored in the second unit 220.

### (Hardware Configuration of Vehicle Dispatch System)

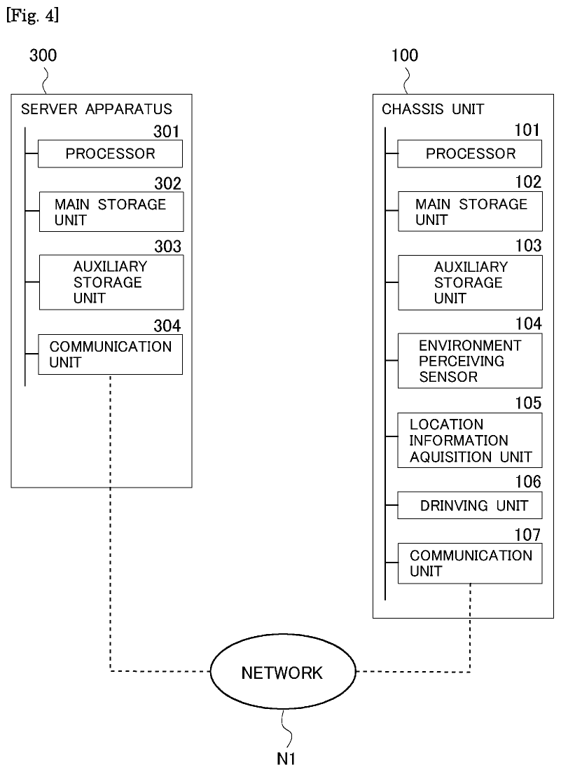

The components of the vehicle dispatch system will now be described specifically. FIG. 4 is a diagram illustrating the hardware configurations of the chassis unit 100 and the server apparatus 300 shown in FIG. 1. While FIG. 4 illustrates only one chassis unit 100, the number of chassis units 100 under the management of the server apparatus 300 may be two or more.

The chassis unit 100 is a mobile unit capable of traveling on the road autonomously pursuant to an operation command. The chassis unit 100 has a processor 101, a main storage unit 102, an auxiliary storage unit 103, an environment perceiving sensor 104, a location information acquisition unit 105, a driving unit 106, and a communication unit 107. The chassis unit 100 used in the system according to the embodiment is an electric car that is driven by an electric motor. The motor of the chassis unit 100 is not limited to an electric motor, but it may be an internal combustion engine or a hybrid system of an internal combustion engine and an electric motor.

The processor 101 may be, for example, a CPU (Central Processing Unit) or a DSP (Digital Signal Processor). The processor 101 executes computation of various information processing to control the chassis unit 100. The main storage unit 102 may include a RAM (Random Access Memory), a ROM (Read Only Memory) and/or the like. The auxiliary storage unit 103 may include, for example, an EPROM (Erasable Programmable ROM) or a hard disk drive (HDD). The auxiliary storage unit 103 may include a removable medium, in other words, a portable recording medium. Examples of the removable medium include a USB (Universal Serial Bus) memory and disc recording media, such as a CD (Compact Disc) and a DVD (Digital Versatile Disc).

What is stored in the auxiliary storage unit 103 includes various programs, various data, and various tables, which can be written into and read out from the auxiliary storage unit 103. The auxiliary storage unit 103 stores an operating system (OS), various programs, and various tables. All or a portion of the aforementioned information and data stored in the auxiliary storage unit 103 may be stored in the main storage unit 102 instead. Likewise, all or a portion of information and data stored in the main storage unit 102 may be stored in the auxiliary storage unit 103 instead.

The environment perceiving sensor 104 is means for sensing the environment of the vehicle, which typically includes a stereo camera, a laser scanner, a LIDAR, a radar, or the like. Information acquired by the environment perceiving sensor 104 is passed to the processor 101.

The location information acquisition unit 105 is a device for acquiring information about the present location of the chassis unit 100. The location information acquisition unit 105 typically includes a GPS receiver. The location information acquisition unit 105 acquires information about the present location of the chassis unit 100 repeatedly at predetermined intervals. The location information acquired by the location information acquisition unit 105 is sent to the server apparatus 300 through the communication unit 107, which will be described later. Thus, location information of the chassis unit 100 is sent from the chassis unit 100 to the server apparatus 300 repeatedly at predetermined intervals. In consequence, the server apparatus 300 can recognize the present location of each chassis unit 100.

The driving unit 106 is a device that drives the chassis unit 100. The driving unit 106 includes, for example, an electronic motor, a braking device, and a steering device.

The communication unit 107 is a device that connects the chassis unit 100 to a network N1. The communication unit 107 connects itself with the network N1 using mobile communications, such as 5G (5th Generation) mobile communications or LTE (Long Term Evolution) mobile communications. Alternatively, the communication unit 107 may connect itself with the network N1 using narrow-band communications, such as DSRC (Dedicated Short Range Communications), or Wi-Fi (registered trademark). Thus, the communication unit 107 can communicate with other devices such as the vehicle body unit 200 and the server apparatus 300 via the network N1. For example, the communication unit 107 sends the present location information acquired by the location information acquisition unit 105 and other information to the server apparatus 300 via the network N1. The network N1 may be, for example, a WAN (Wide Area Network), which may be a global public communication network such as the Internet, or other communication network.

The hardware configuration of the chassis unit 100 is not limited to that illustrated in FIG. 4, but some components may be eliminated, replaced, or added. For example, the chassis unit 100 may be provided with an apparatus used to perform the operation of coupling it with and/or decoupling it from the vehicle body unit 200. Examples of such an apparatus include a heavy machine equipped with a lift or a crane and an electromagnet device. Various processing executed by the chassis unit 100 may be executed by either hardware or software.

The server apparatus 300 is an apparatus that manages the chassis unit 100 and the vehicle body unit 200. The server apparatus 300 constitutes the information processing apparatus according to the disclosure. The server apparatus 300 has a configuration as an ordinary computer. The server apparatus 300 has a processor 301, a main storage unit 302, an auxiliary storage unit 303, and a communication unit 304. The processor 301, the main storage unit 302, the auxiliary storage unit 303, and the communication unit 304 are interconnected by buses. The processor 301, the main storage unit 302, and the auxiliary storage unit 303 are similar to their corresponding components of the chassis unit 100 and therefore will not be described further. The communication unit 304 performs communication of information between the server apparatus 300 and external devices. The communication unit 304 may include, for example, a LAN (Local Area Network) interface board or a wireless communication circuit for wireless communication. The LAN interface board or the wireless communication circuit is connected to the network N1. The hardware configuration of the server apparatus 300 is not limited to that illustrated in FIG. 4, but some components may be eliminated, replaced, or added. Various processing executed by the server apparatus 300 may be executed by either hardware or software.

### (Functional Configuration of Chassis Unit)

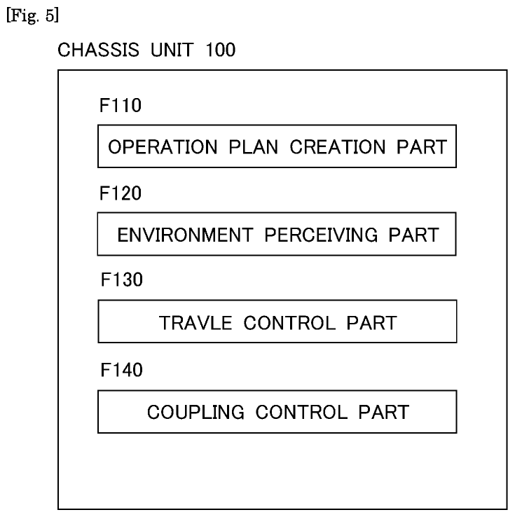

The functional configuration of the chassis unit 100 will now be described with reference to FIG. 5. As illustrated in FIG. 5, the chassis unit 100 according to this embodiment includes, as functional components, an operation plan creation part F110, an environment perceiving part F120, a travel control part F130, and a coupling control part F140. The chassis unit 100 implements these functional components by executing programs stored in the main storage unit 102 or the auxiliary storage unit 103 by the processor 101. One or some of the operation plan creation part F110, the environment perceiving part F120, the travel control part F130, and the coupling control part F140 may be implemented entirely or partly by a hardware circuit(s). One or some of the above functional components or a part of the processing of them may be implemented by another computer(s) connected to the network N1. For example, the processing executed as the operation plan creation part F110, the processing executed as the environment perceiving part F120, the processing executed as the travel control part F130, and the processing executed as the coupling control part F140 may be executed by different computers.

The operation plan creation part F110 is configured to create an operation plan of the chassis unit 100 on the basis of an operation command sent from the server apparatus 300. The operation plan includes data specifying a route along which the chassis unit 100 is to travel and an operation(s) that the chassis unit 100 is to perform in a part or the entirety of the route. Examples of data included in the operation plan are as follows.

(1) Data that Specifies a Route Along which the Chassis Unit 100 is Planned to Travel (Planned Travel Route) by a Set of Road Links

The planned travel route mentioned above may be created, for example, by the operation plan creation part F110 based on the command sent from the server apparatus 300 using map data stored in the auxiliary storage unit 103 or other storage means. Alternatively, the planned travel route may be created using an external service or supplied by the server apparatus 300.

(2) Data that Specifies an Operation(s) to be Performed by the Chassis Unit 100 at a Certain Location(s) in the Planned Travel Route

An example of the aforementioned certain location is a location at which the chassis unit 100 and the vehicle body unit 200 are decoupled from or coupled to each other or a destination to which the vehicle body unit 200 is to be transported. An example of the operation to be performed by the chassis unit 100 at that location includes, but is not limited to, decoupling/coupling the chassis unit 100 from/to the vehicle body unit 200.

The environment perceiving part F120 is configured to perceive the environment around the chassis unit 100 using data acquired by the environment perceiving sensor 104. Examples of what is perceived by the environment perceiving part F120 include, but are not limited to, the number and the position of lanes, the number and the position of vehicles present around the chassis unit 100, the number and the position of obstacles present around the chassis unit 100, the structure of the road, and road signs. What is perceived by the environment perceiving part F120 may include anything that is useful for autonomous traveling of the chassis unit 100. The environment perceiving part F120 may be configured to perform tracking of a perceived object. For example, the environment perceiving part F120 may be configured to calculate the relative speed of the perceived object from the difference between the coordinates of the object determined in a previous step and the present coordinates of it.

The travel control part F130 is configured to control the travel of the chassis unit 100 on the basis of the operation plan created by the operation plan creation part F110, environment data created by the environment perceiving part F120, and the location information of the chassis unit 100 acquired by the location information acquisition unit 105. For example, the travel control part F130 causes the chassis unit 100 to travel along the planned travel route created by the operation plan creation part F110. In doing so, the travel control part F130 causes the chassis unit 100 to travel so that obstacles will not enter a predetermined safety zone around the chassis unit 100. A known method may be employed to cause the chassis unit 100 to travel autonomously. Moreover, the travel control part F130 has the function of controlling the travel of the chassis unit 100 pursuant to the command sent from the server apparatus 300.

The coupling control part F140 is configured to control coupling and decoupling of the chassis unit 100 and the vehicle body unit 200 to and from each other. In the case where the operations of coupling and decoupling the chassis unit 100 and the vehicle body unit 200 are carried out by an external apparatus, the coupling control part F140 controls this external apparatus by wireless communication or the like to carry out the operations of coupling and decoupling the chassis unit 100 and the vehicle body unit 200. In the case where the chassis unit 100 is provided with an apparatus that carries out the operations of coupling and decoupling the chassis unit 100 and the vehicle body unit 200, the coupling control part F140 controls this apparatus to carry out the operations of coupling and decoupling the chassis unit 100 and the vehicle body unit 200.

### (Functional Configuration of Server Apparatus)

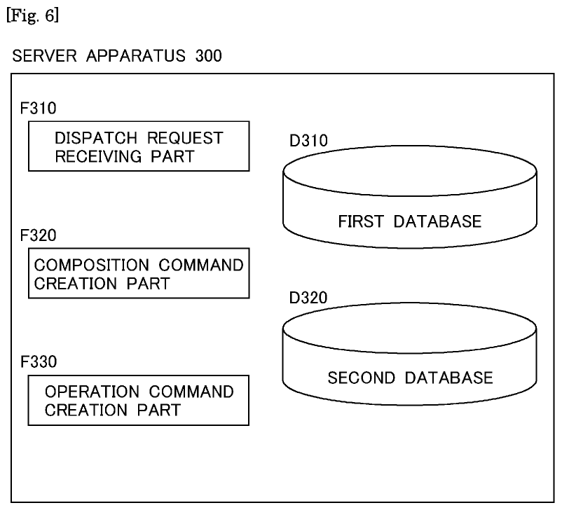

The functional configuration of the server apparatus 300 will be described next with reference to FIG. 6. As illustrated in FIG. 6, the server apparatus 300 in the system according to this embodiment includes, as functional components, a dispatch request receiving part F310, a composition command creation part F320, an operation command creation part F330, a first database D310, and a second database D320. The server apparatus 300 implements the dispatch request receiving part F310, the composition command creation part F320, and the operation command creation part F330 by executing programs stored in the main storage unit 302 or the auxiliary storage unit 303 by the processor 301. One or some of the dispatch request receiving part F310, the composition command creation part F320, and the operation command creation part F330 may be implemented entirely or partly by a hardware circuit(s). One or some of the dispatch request receiving part F310, the composition command creation part F320, and the operation command creation part F330 or a part of the processing of them may be implemented by another computer(s) connected to the network N1. For example, the processing executed as the dispatch request receiving part F310, the processing executed as the composition command creation part F320, and the processing executed as the operation command creation part F330 may be executed by different computers.

The first database D310 and the second database D320 are created by a database management system program (DBMS program) executed by the processor 301. Specifically, the first database D310 and the second database D320 are created by managing data stored in the auxiliary storage unit 303 by the DBMS program. The first database D310 and the second database D320 are, for example, relational databases.

What is stored in the first database D310 is information about the units used to compose vehicle body units 200. The first database D310 stores information about each unit and information about a composition site where maintenance and management of each unit are performed, which are linked with each other. The first database D310 constitutes the first storage unit according to this disclosure.

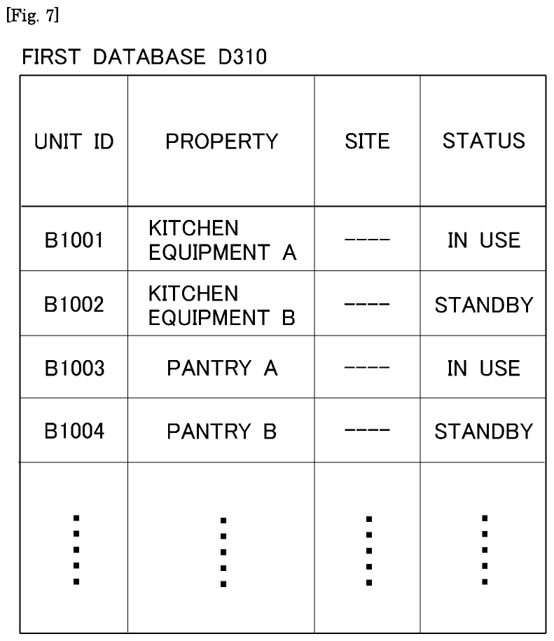

An exemplary structure of the information stored in the first database D310 will be described with reference to FIG. 7. FIG. 7 illustrates the structure of a table stored in the first database D310. The structure of the table stored in the first database D310 (which will be also referred to as “unit information table” hereinafter) is not limited to that illustrated in FIG. 7, but some fields may be added, changed, or removed fitly.

The unit information table in FIG. 7 has the fields of unit ID, property, site, and status. What is stored in the unit ID field is information (unit ID) identifying each of the units that are under the management of the server apparatus 300.

What is stored in the property field is information about properties of each unit. For example, in the case of a unit provided with kitchen equipment of type A, the information “kitchen equipment A” is stored in the property field. In the case of a unit provided with kitchen equipment of type B, the information “kitchen equipment B” is stored in the property field. In the case of a unit provided with a pantry of type A, the information “pantry A” is stored in the property field. In the case of a unit provided with a pantry of type B, the information “pantry B” is stored in the property field.

What is stored in the site field is information identifying the composition site where maintenance and management of each unit are performed. The information stored in the site field may be an ID assigned to the composition site or information indicating the location of the composition site, such as the address or the coordinates on a map (or longitude and latitude) of the composition site.

What is stored in the status field is information indicating the status of each unit. For example, when the unit is in use or planned to be used to fulfill a vehicle dispatch request, the information “in use” is stored in the status field. When the unit is not planned to be used and on standby at a composition site, the information “standby” is stored in the status field.

What is stored in the second database D320 is information about the chassis unit 100. The second database D320 stores information about the location of each chassis unit 100 and information about the operation status of the chassis unit 100, which are linked with each other. The second database D320 constitutes the second storage unit according to this disclosure.

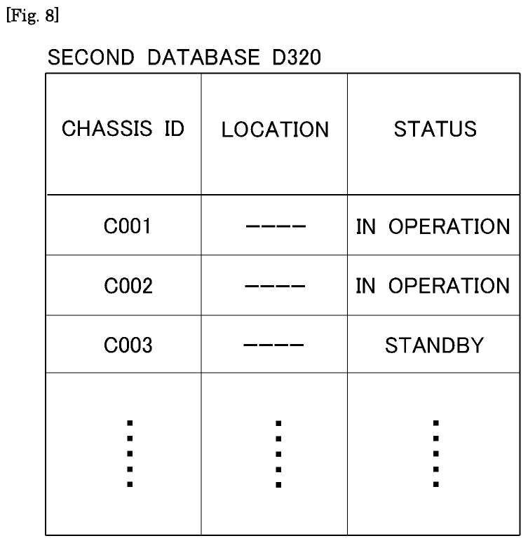

An exemplary structure of the information stored in the second database D320 will be described with reference to FIG. 8. FIG. 8 illustrates the structure of a table stored in the second database D320. The structure of the table stored in the second database D320 (which will be also referred to as “chassis information table” hereinafter) is not limited to that illustrated in FIG. 8, but some fields may be added, changed, or removed fitly.

The chassis information table in FIG. 8 has the fields of chassis ID, location, and status. What is stored in the chassis ID field is information identifying each of the chassis units 100 under the management of the server apparatus 300 (chassis ID).

What is stored in the location field is information indicating the present location of each chassis unit 100. The information stored in the location field may be the address of the place where each chassis unit 100 is presently located or information indicating the coordinates on a map (or longitude and latitude) of the present location of the chassis unit 100.

What is stored in the status field is information indicating the status of each chassis unit 100. For example, when the chassis unit 100 is in operation or planned to be in operation with a vehicle body unit 200 mounted thereon, the information “in operation” is stored in the status field. When no vehicle body unit 200 is mounted on the chassis unit 100 and the chassis unit 100 is not planned to be in operation, the information “standby” is stored in the status field. The chassis units 100 on standby are not limited to chassis units 100 parked at specific places but include chassis units 100 traveling on the road.

The dispatch request receiving part F310 receives a vehicle dispatch request from a user. The vehicle dispatch request may be sent from a terminal used by the user to the server apparatus 300 directly or via a vehicle dispatch center or the like. The dispatch request receiving part F310 receives the vehicle dispatch request sent from the user's terminal through the communication unit 304. As described above, the vehicle dispatch request in the system according to this embodiment contains information about the place of getting-on desired by the user, information about the place of getting-off desired by the user, information about kitchen equipment that the user wishes to use, and information about food materials that the user wishes to use. The vehicle dispatch request received by the dispatch request receiving part F310 is passed to the composition command creation part F320 and the operation command creation part F330.

The composition command creation part F320 creates a command to compose a vehicle body unit 200 desired by the user (i.e. composition command). In creating the composition command, the composition command creation part F320 firstly determines a unit (first unit 210) provided with kitchen equipment that the user wishes to use and a unit (second unit 220) that can store the food materials that the user wishes to use. Specifically, the composition command creation part F320 firstly determines the type of kitchen equipment (type A or type B) and the type of pantry (type A or type B) in which the food materials desired by the user can be stored. The composition command creation part F320 accesses the first database D310 to extract units for which information indicating the type of kitchen equipment determined as above is stored in the property field and the information “standby” is stored in the status field. The units extracted in this way will also be referred to as “potential first units” hereinafter. Moreover, the composition command creation part F320 accesses the first database D310 to extract units for which information indicating the type of pantry determined as above is stored in the property field and the information “standby” is stored in the status field. The units extracted in this way will also be referred to as “potential second units” hereinafter. Then, the composition command creation part F320 selects a combination of a potential first unit and a potential second unit that are on standby at the same composition site from among the potential first units and the potential second units extracted as above. In other words, the composition command creation part D320 selects a combination of a potential first unit and a potential second unit for which information indicating the same composition site is stored in the respective site fields. In cases where there are a plurality of combinations of a potential first unit and a potential second unit that are on standby at the same composition site, the composition command creation part D320 may select a combination of a potential first unit and a potential second unit that are on standby at the composition site closest to the place of user's getting-on. The potential first unit in the combination thus selected is determined as the first unit 210, and the potential second unit in the combination thus selected is determined as the second unit 220.

After determining the first unit 210 and the second unit 220 as above, the composition command creation part F320 determines the specific composition site at which the vehicle body unit 200 including the first unit 210 and the second unit 220 is to be composed. The composition command creation part F320 in the system of this embodiment selects the composition site where the first unit 210 and the second unit 220 selected as above are on standby as the specific composition site. After determining the specific composition site, the composition command creation part F320 creates a composition command. The composition command created by the composition command creation part F320 contains the unit ID of the first unit 210, the unit ID of the second unit 220, and information about food materials to be stored in the second unit (e.g. information about the items of food materials and amounts thereof). The composition command created by the composition command creation part F320 is sent to the specific composition site through the communication unit 304. The composition command creation part F320 sends information about the specific composition site to the operation command creation part F330.

The operation command creation part F330 creates a command (operation command) to cause a chassis unit 100 to travel with the vehicle body unit 200 composed at the specific composition site mounted thereon. In creating the operation command, the operation command creation part F330 firstly determines a chassis unit on which the aforementioned vehicle body unit 200 is to be mounted. This chassis unit 100 will also be referred to as “chassis unit for operation” hereinafter. Specifically, the operation command creation part F330 accesses the second database D320 to extract chassis units 100 whose status indicated by the information stored in the status field of the chassis information table is “standby”. Then, the operation command creation part F330 selects the chassis unit 100 whose present location indicated by the information stored in the location field is closest to the aforementioned specific composition site among the chassis units 100 extracted as above, as the chassis unit for operation. If there is a chassis unit 100 that is on standby at the specific composition site among the chassis units 100 on standby, the operation command creation part F330 may select this chassis unit 100 as the chassis unit for operation.

After selecting the chassis unit for operation, the operation command creation part F330 creates a command (operation command) to cause a chassis unit 100 to travel with the vehicle body unit 200 mounted thereon. The operation command includes the following first to fifth commands:
first command: a command to couple the chassis unit for operation to the vehicle body unit 200 at the specific composition site
second command: a command to cause the chassis unit for operation to travel from the specific composition site to the place of getting-on
third command: a command to pick up the user at the place of getting-on
fourth command: a command to cause the chassis unit for operation to travel from the place of getting-on to the place of getting-off
fifth command: a command to drop off the user at the place of getting-off.

In the case where the chassis unit for operation is presently located at a place other than the specific composition site, the first command should include a command to cause the chassis unit for operation to travel from its present location to the specific composition site.

The operation command created by the operation command creation part F330 is sent to the chassis unit for operation through the communication unit 304.

### (Process Performed by Server Apparatus)

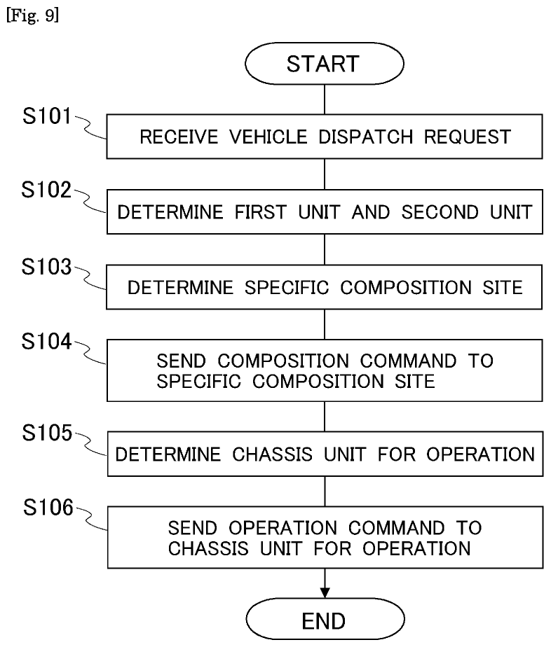

A process performed by the server apparatus 300 in the system according to the embodiment will be described with reference to FIG. 9. FIG. 9 is a flow chart of the process performed by the server apparatus 300 when it receives a vehicle dispatch request.

In the process according to the flow chart of FIG. 9, when the communication unit 304 of the server apparatus 300 receives a vehicle dispatch request, it is passed to the dispatch request receiving part F310. Thus, the dispatch request receiving part F310 receives the vehicle dispatch request (step S101). The vehicle dispatch request received is passed from the dispatch request receiving part F310 to the composition command creation part F320 and the operation command creation part F330.

The composition command creation part F320 selects a first unit 210 and a second unit 220 on the basis of the vehicle dispatch request (step S102). Specifically, the composition command creation part F320 determines the type of kitchen equipment and the items of food materials desired by the user on the basis of information about the kitchen equipment and information about food materials contained in the vehicle dispatch request. The composition command creation part F320 accesses the first database D310 to extract potential first units. As described above, the potential first units are units for which information indicating the type of kitchen equipment determined as above is stored in the property field of the unit information table and the information “standby” is stored in the status field of the unit information table. Moreover, the composition command creation part F320 accesses the first database D310 to extract potential second units. The potential second units are units for which information indicating the type of pantry that can stock the type of food materials determined as above is stored in the property field of the unit information table and the information “standby” is stored in the status field of the unit information table. The composition command creation part F320 selects a combination of a potential first unit and a potential second unit that are on standby at the same composition site among the potential first units and the potential second units extracted as above. The composition command creation part F320 determines the potential first unit in the combination thus selected as the first unit 210. Moreover, the composition command creation part F320 determines the potential second unit in the combination thus selected as the second unit 220.

After determining the first unit 210 and the second unit 220, the composition command creation part F320 determines the specific composition site at which the vehicle body unit 200 is to be composed (step S103). In the system of this embodiment, the composition command creation part F320 determines the composition site at which the first unit 210 and the second unit 220 in the combination determined in step S102 are on standby as the specific composition site. Specifically, the composition command creation part F320 accesses the unit information table associated with the first unit 210 or the second unit 220 to find the composition site specified in the site field. Then, the composition command creation part F320 determines the composition site thus found as the specific composition site. The composition command creation part F320 sends information about the specific composition site (e.g. information indicating the location of the specific composition site) to the operation command creation part F330.

After determining the first unit 210, the second unit 220, and the specific composition site, the composition command creation part F320 sends a composition command to the specific composition site (step S104). Specifically, the composition command creation part F320 firstly creates a command (composition command) to compose a vehicle body unit 200 including the first unit 210 and the second unit 220. The composition command contains the unit ID of the first unit 210, the unit ID of the second unit 220, and information about food materials to be stored in the second unit 220. This information will also be referred to as “food material information” hereinafter. The composition command is sent to the specific composition site through the communication unit 304.

The operation command creation part F330 selects a chassis unit for operation on the basis of the information about the specific composition site and the vehicle dispatch request (step S105). For example, the operation command creation part F330 accesses the second database D320 to extract chassis units 100 for which the information “standby” is stored in the status field of the chassis information table. Then, the operation command creation part F330 determines the chassis unit 100 whose present location indicated by the information stored in the location field of the chassis information table is closest to the specific composition site, as the chassis unit for operation. If there is a chassis unit 100 on standby at the specific composition site among the chassis units 100 on standby, the operation command creation part F330 selects it preferentially as the chassis unit for operation.

The operation command creation part F330 sends an operation command to the chassis unit for operation (step S105). Specifically, the operation command creation part F330 firstly creates the operation command on the basis of the present location of the chassis unit 100 selected as the chassis unit for operation, the location of the specific composition site, and the places of getting-on and getting-off desired by the user. The operation command includes the above-described first to fifth commands. The operation command is sent to the chassis unit 100 selected as the chassis unit for operation through the communication unit 304.

At the specific composition site that has received the composition command, the unit selected as the first unit 210 and the unit selected as the second unit 220 are identified based on the unit IDs contained in the composition command. Then, a vehicle body unit 200 is composed by assembling these two units. Moreover, food materials are loaded into the vehicle body unit 200 at the specific composition site on the basis of food material information contained in the composition command. The food materials loaded into the vehicle body unit 200 is stored in the second unit 220. The vehicle body unit 200 thus composed includes the first unit 210 provided with the kitchen equipment desired by the user and the second unit 220 in which the materials desired by the user are stored.

When the chassis unit 100 receives the operation command, the operation plan creation part F110 of the chassis unit 100 creates an operation plan based on the operation command. As described above, the operation plan includes data that specifies a planned travel route of the chassis unit 100 by a set of road links and data that specifies operations to be performed by the chassis unit 100 at certain locations in the planned travel route. The planned travel route is a route from the present location of the chassis unit 100 to the place of getting-off via the specific composition site and the place of getting-on. The locations at which operations are to be performed include the specific composition site, the place of user's getting-on, and the place of user's getting-off. The operation to be performed by the chassis unit 100 at the specific composition site is the operation of coupling the chassis unit 100 to the vehicle body unit 200. The operation to be performed by the chassis unit 100 at the place of user's getting-on is the operation of letting the user get on the vehicle body unit 200. This operation may include, for example, the operation of unlocking the entrance door and/or the operation of opening and closing the entrance door. The operation to be performed by the chassis unit 100 at the place of user's getting-off is the operation of letting the user get off the vehicle body unit 200. This operation may include, for example, the operation of unlocking the entrance door and/or the operation of opening and closing the entrance door.

After the operation plan is created as above, the travel control part F130 of the chassis unit 100 starts to cause the chassis unit 100 to travel. Specifically, the travel control part F130 controls the travel of the chassis unit 100 by controlling the driving unit 106 thereof on the basis of the operation plan mentioned above, environment data generated by the environment perceiving part F120, and location information acquired by the location information acquisition unit 105. This enables the chassis unit 100 to travel autonomously from its present location to the specific composition site by autonomous driving. After the chassis unit 100 arrives at the specific composition site, the coupling control part F140 thereof controls an external apparatus or an apparatus provided on the chassis unit 100 to couple the chassis unit 100 to the vehicle body unit 200. After the completion of the operation of coupling the chassis unit 100 to the vehicle body unit 200, the travel control part F130 of the chassis unit 100 restarts to cause the chassis unit 100 to travel. Specifically, the travel control part F130 causes the chassis unit 100 to travel autonomously from the specific composition site to the place of user's getting-on by autonomous driving by controlling the driving unit 106 on the basis of the operation plan, the environment data, and the location information. Thus, the chassis unit 100 can transport the vehicle body unit 200 from the specific composition site to the place of user's getting-on. After the chassis unit 100 arrives at the place of user's getting-on, the operation of unlocking the entrance door and/or the operation of opening and closing the entrance door is performed. This operation may be performed by the vehicle body unit 200 on the basis of a command sent to it from the chassis unit 100. Thus, the user can get on the vehicle body unit 200. After the user gets on the vehicle body unit 200, the travel control part F130 restarts to cause the chassis unit 100 to travel. Specifically, the travel control part F130 causes the chassis unit 100 to travel autonomously from the place of user's getting-on to the place of getting-off desired by the user by autonomous driving by controlling the driving unit 106 on the basis of the operation plan, the environment data, and the location information. Thus, the chassis unit 100 can transport the vehicle body unit 200 with the user aboard from the place of getting-on to the place of getting-off. During the transportation, the user can make a meal using the kitchen equipment of the first unit 210 and the food materials stored in the second unit 220. After the chassis unit 100 arrives at the place of getting-off, the operation of unlocking the entrance door and/or the operation of opening and closing the entrance door is performed, so that the user in the vehicle body unit 200 can get off the vehicle.

The vehicle dispatch system according to this embodiment enables the user traveling by the separable vehicle 1 to make a meal at will while traveling. This improves the convenience of the user of the separable vehicle 1.

### <First Modification>

When the separable vehicle 1 described in the above description of the embodiment is used by a user, it is necessary to charge the user a fare commensurate with the service rendered. The fare may be calculated taking into account the type of the kitchen equipment provided in the first unit 210 and the items of food materials stored in the second unit 220 and their amounts. For example, the server apparatus 300 calculates a first fee commensurate with the type of the kitchen equipment provided in the first unit 210. Furthermore, the server apparatus 300 calculates a second fee commensurate with the items of food materials stored in the second unit 220 and their amounts. Still further, the server apparatus 300 calculates a third fee commensurate with at least one of the travel time and the travel distance from the place of getting-on to the place of getting off. Then, the server apparatus 300 calculates the fare on the basis of the first to third fees. The fare calculated in this way is commensurate with the kitchen equipment and the food materials used by the user. The first fee and the second fee may be fixed amounts.

### <Second Modification>

In the above-described system according to the embodiment and the first modification, the processing of receiving a vehicle dispatch request, the processing of determining the first and second units, the processing of determining the specific composition site, the processing of creating and sending a composition command, and the processing of creating an operation command are executed in the server apparatus. Alternatively, the above processing may be executed in the chassis unit 100. In other words, the processing executed by the dispatch request receiving part F310, the processing executed by the composition command creation part F320, and the processing executed by the operation command creation part F330 may be executed in the chassis unit 100. Specifically, the chassis unit 100 may implement the functions same as the dispatch request receiving part F310, the composition command creation part F320, and the operation command creation part F330 by executing a program(s) stored in the main storage unit 102 or the auxiliary storage unit 103 by the processor 101.

### <Others>

The above embodiment and modification have been described only by way of example. Changes can be made to the above embodiment and modification without departing from the essence of the present disclosure. For examples, features of the above embodiment and modification may be employed in any possible combination.

The processing and means that have been described in this disclosure may be employed in any combination so long as it is technically feasible to do so. One, some, or all of the processes that have been described as processes performed by a single apparatus may be performed by a plurality of apparatuses in a distributed manner. One, some, or all of the processes that have been described as processes performed by a plurality of apparatuses may be performed by a single apparatus. The hardware configuration employed to implement various functions in a computer system may be modified flexibly.

The technology according to this disclosure can be carried out by supplying a computer program(s) (or information processing program(s)) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer or through a network. The computer-readable, non-transitory storage medium refers to a recording medium that can store information, such as data and programs, electrically, magnetically, optically, mechanically, or chemically in such a way as to allow the computer or the like to read the stored information. Examples of such a recording medium include any type of disc medium including a magnetic disc, such as a floppy disc (registered trademark) and a hard disk drive (HDD), and an optical disc, such as a CD-ROM, a DVD, and a Blu-ray disc. Further examples of the recording medium include a read-only memory (ROM), a random access memory (RAM), an EPROM, an EEPROM, a magnetic card, a flash memory, an optical card, and a solid state drive (SSD).

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An information processing apparatus comprising a controller equipped with at least one processor,
the controller configured to execute the processing of
receiving a vehicle dispatch request containing information designating kitchen equipment used to make a meal and information designating a food material used to make a meal;
determining a first unit provided with the kitchen equipment designated by the vehicle dispatch request and a second unit capable of storing the food material designated by the vehicle dispatch request;
sending a composition command to a specific composition site, the composition command being a command to compose a vehicle body unit including the first unit and the second unit; and
sending an operation command to a chassis unit capable of traveling autonomously on which a plurality of units can be mounted, the operation command being a command to cause the chassis unit to travel with the vehicle body unit composed at the specific composition site mounted thereon.

2. The information processing apparatus according to claim 1, further comprising a first storage unit in which information about the types of units available at each composition site is stored, wherein the controller determines the specific composition site on the basis of data stored in the first storage unit.

3. The information processing apparatus according to claim 1, further comprising a second storage unit in which information about the location of each chassis unit and information about the operation status of each chassis unit are stored in a linked manner, wherein the controller determines a chassis unit on which the vehicle body unit is to be mounted on the basis of data stored in the second storage unit.

4. The information processing apparatus according to claim 1, wherein the vehicle dispatch request further contains information about a place of getting-on and a place of getting-off desired by a user.

5. The information processing apparatus according to claim 4, wherein the operation command includes:
a command to couple the chassis unit to the vehicle body unit at the specific composition site;
a command to cause the chassis unit to travel from the specific composition site to the place of getting-on;
a command to pick up the user at the place of getting-on;
a command to cause the chassis unit to travel from the place of getting-on to the place of getting-off and
a command to drop off the user at the place of getting-off.

6. The information processing apparatus according to claim 4, wherein the controller further executes the processing of calculating a fare on the basis of a first fee as a fee for the use of the first unit, a second fee as a fee for the use of the second unit, and a third fee as a fee for the travel from the place of getting-on to the place of getting-off.

7. The information processing apparatus according to claim 6, wherein the first fee is calculated on the basis of the type of the kitchen equipment provided in the first unit.

8. The information processing apparatus according to claim 6, wherein the second fee is calculated on the basis of the item of a food material stored in the second unit and its amount.

9. The information processing apparatus according to claim 6, wherein the third fee is calculated on the basis of at least one of the travel distance from the place of getting-on to the place of getting-off and the time of travel from the place of getting-on to the place of getting-off.

10. An information processing method comprising the following steps of processing executed by a computer:
receiving a vehicle dispatch request containing information designating kitchen equipment used to make a meal and information designating a food material used to make a meal;
determining a first unit provided with the kitchen equipment designated by the vehicle dispatch request and a second unit capable of storing the food material designated by the vehicle dispatch request;
sending a composition command to a specific composition site, the composition command being a command to compose a vehicle body unit including the first unit and the second unit; and
sending an operation command to a chassis unit capable of traveling autonomously on which a plurality of units can be mounted, the operation command being a command to cause the chassis unit to travel with the vehicle body unit composed at the specific composition site mounted thereon.

11. The information processing method according to claim 10, wherein the computer is provided with a first storage unit in which information about the types of units available at each composition site is stored, and the specific composition site is determined on the basis of data stored in the first storage unit in the step of sending the composition command to the specific composition site.

12. The information processing method according to claim 10, wherein the computer is provided with a second storage unit in which information about the location of each chassis unit and information about the operation status of each chassis unit are stored in a linked manner, and the chassis unit is determined on the basis of data stored in the second storage unit in the step of sending the operation command to the chassis unit.

13. The information processing method according to claim 10, wherein the vehicle dispatch request further contains information about a place of getting-on and a place of getting-off desired by a user.

14. The information processing method according to claim 13, wherein the operation command includes:
a command to couple the chassis unit to the vehicle body unit at the specific composition site;
a command to cause the chassis unit to travel from the specific composition site to the place of getting-on;
a command to pick up the user at the place of getting-on;
a command to cause the chassis unit to travel from the place of getting-on to the place of getting-off and
a command to drop off the user at the place of getting-off.

15. The information processing method according to claim 13, further comprising the step of processing executed by the computer of calculating a fare on the basis of a first fee as a fee for the use of the first unit, a second fee as a fee for the use of the second unit, and a third fee as a fee for the travel from the place of getting-on to the place of getting-off.

16. The information processing method according to claim 15, wherein the first fee is calculated on the basis of the type of the kitchen equipment provided in the first unit.

17. The information processing method according to claim 15, wherein the second fee is calculated on the basis of the item of a food material stored in the second unit and its amount.

18. The information processing method according to claim 15, wherein the third fee is calculated on the basis of at least one of the travel distance from the place of getting-on to the place of getting-off and the time of travel from the place of getting-on to the place of getting-off.

19. A vehicle comprising a controller equipped with at least one processor,
the controller configured to execute the processing of
receiving a vehicle dispatch request containing information designating kitchen equipment used to make a meal and information designating a food material used to make a meal;
determining a first unit provided with the kitchen equipment designated by the vehicle dispatch request and a second unit capable of storing the food material designated by the vehicle dispatch request;
sending a composition command to a specific composition site, the composition command being a command to compose a vehicle body unit including the first unit and the second unit;
creating an operation plan for traveling with the vehicle body unit composed at the specific composition site mounted on the vehicle; and
operating pursuant to the operation command.

20. The vehicle according to claim 19, wherein the controller obtains information about the types of units available at each composition site and determines the specific composition site on the basis of the obtained information.
